(19) United States
(12) Patent Application Publication
(10) Pub. No.: US 2003/0112264 A1
(43) Pub. Date: Jun. 19, 2003

(54) Real time authoring

(75) Inventors: Andrew J. Duguid, Edenbridge (GB); Michael J. Plummer, Redhill (GB); Nicholas P. Westoby, Brighton (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/315,811

(22) Filed: Dec. 10, 2002

(30) Foreign Application Priority Data
Dec. 13, 2001 (GB) 0129793.6

(51) Int. Cl. G09G 5/00

(52) U.S. Cl. 345/719

(57) ABSTRACT

The invention comprises a method and an associated broadcasting system BS and viewer apparatus VUI for providing interactive media coverage for a real time video broadcast of a live action event, the method comprising; i) in a first data stream 4, broadcasting video of the live action event for receipt by one or more viewer apparatus; ii) locating the position of subjects S1, S2, S3, S4 of the live action event in real time, and iii) in a second data stream 2, transmitting position data acquired in step ii) to the one or more viewer apparatus VUI substantially simultaneously with the first data stream 4.

The present invention relates to a broadcasting system and method which enables authors of interactive TV and internet broadcasts to monitor and update real time aspects of their applications automatically, and viewers of a broadcast to manipulate information provided in real time.

The provision of real time data during the live broadcast of motor racing events is known from “Real-Time GPS FX”; Ken Miles and Tom Ford, GPS World; September 2001; pp 12 -24. The described system uses GPS receivers located on each racing car so that the cars may be tracked and located in real time. A sophisticated telemetry system relays positional data of the cars to a control centre. At the control centre, the system generates graphical effects relevant to the current view of an individual race camera by directly coupling real time vehicle positions to the broadcast screen images. These graphical effects become part of the broadcast picture and the viewer is provided with no option as to whether or not to view these effects. There is no known facility to allow user manipulation of images broadcast in real time.

It is known from U.S. Pat. No. 5,708,845 to provide broadcast, pre-recorded media in an interactive digital form. In one example, specific objects in a movie may have their location in certain frames of the movie mapped and by means of an associated interactive data media program can be manipulated by a user, via a suitable user operating system, to perform previously authored functions outside of the original movie script. As live events are unpredictable, objects cannot be mapped in this manner hence, this technology cannot be used to provide an interactive experience based on events broadcast in real time.

An object of the present invention is to provide a broadcasting system and method for facilitating interactive participation and individual user authoring, real time during a live action video broadcast.

According to a first aspect, the present invention provides a method for providing interactive media coverage for a real time video broadcast of a live action event comprising;

i) in a first data stream, broadcasting video of the live action event for receipt by one or more viewer apparatus;

ii) locating the position of the subjects of the live action event in real time, and

iii) in a second data stream, transmitting position data acquired in step ii) to the one or more viewer apparatus substantially simultaneously with the first data stream.

By transmitting the live action video broadcast and the position data in separate data streams, it is made possible for the viewer to manipulate the second data stream through an interactive application without interfering with the video broadcast. It is to be understood that whilst two separate data streams are provided they may be transmitted to the viewer apparatus in tandem. The second data stream may be multiplexed with said first data stream. It is also possible that further data streams are transmitted to the viewer apparatus.

Transmissions may be made through cable, satellite, radio or any other known broadcasting means.

The position data may have associated therewith pre-authored data relevant to the subjects or other aspects of the live action event. An interactive application may facilitate the viewer to view or not view the position data and/or any pre-authored data associated therewith.

Suitable methods for obtaining the position data will no doubt occur to the skilled addressee and may, without limitation, include the use of GPS telemetry or low power, low bandwidth radio telemetry. For example, signal transmitters may be attached to subjects of the live action event and one or more signal receivers may be used to detect the actual or relative positions of the subjects. Desirably, where subjects are people or animals, shock proof signal transmitters may be used. In alternative arrangements, the venue in which the live action broadcast is held may be equipped with sensors which respond to certain movements or actions of the subjects thereby locating their position, for example, pressure sensors at predetermined locations may signal when a subject has passed over the sensor.

The transmitters may transmit subject ID data along with the signal for interrogation to enable the relatively straightforward appendage of relevant pre-authored information thereto. Alternatively or in addition, the transmitters may be configured to respond to queries as to its position made by a local server. For example, but without limitation, the transmitters may be attached to a racing car, a golf ball, a sportspersons footwear or head gear, or a horses bridle.

By means of at least one signal receiver, the position of a moving subject can be established automatically by a local server using standard position location techniques, for example triangulation. The position data calculated by the local server is then relayed to a broadcast control centre or directly to a viewer apparatus in real time.

An authoring system may be automatically or manually controlled to link certain subject specific information, along with the positional data, with particular subjects.

Pre-authored information to be associated with the position data may include, but is not strictly limited to historical statistical data associated with a particular subject, for example, when the subject takes the lead in a race, or scores a goal in a ball game, or takes up a batting position in a cricket or baseball match, relevant historical statistical data can be automatically displayed. Other pre-authored data may comprise information calculated from the position data, such as the speed of a subject, the route it has taken, its position relative to other subjects (for example in a race), total distance travelled, or topographical data describing, for instance, a map of each hole on a golf course.

In another aspect, the invention provides a broadcasting system for performing the aforementioned method of the invention, the broadcasting system comprising; means for receiving video data from the live action event; means for receiving position data of subjects of the live action event; means for processing the data and means for transmitting the first and second data streams for receipt by a viewer apparatus.

In yet another aspect the invention provides a viewer apparatus comprising means for receiving, processing and displaying images associated with the two data streams provided by the method and broadcasting system of the invention.

The viewer apparatus may further comprise means for receiving an interactive media program associated with one or both of the data streams. Optionally, such a program may be received by down loading from the same source as one or both of the data streams.

Desirably, the viewer apparatus may also comprise a hand-held controller such as a TV remote control or a pointing device such as a computer mouse which is configured to enable the viewer to manipulate the interactive data of the second data stream via an interactive application such as an interactive data media program.

By using the interactive application, the pre-authored and/or position data may be selectively displayed.

The invention is particularly suited to live sporting events but equally may find application in the broadcast of live music events or other shows where the subjects of interest are perhaps known in advance.

For the purposes of exemplification, there now follows a brief description of one embodiment of the method of the invention as shown in the accompanying Figures, in which:

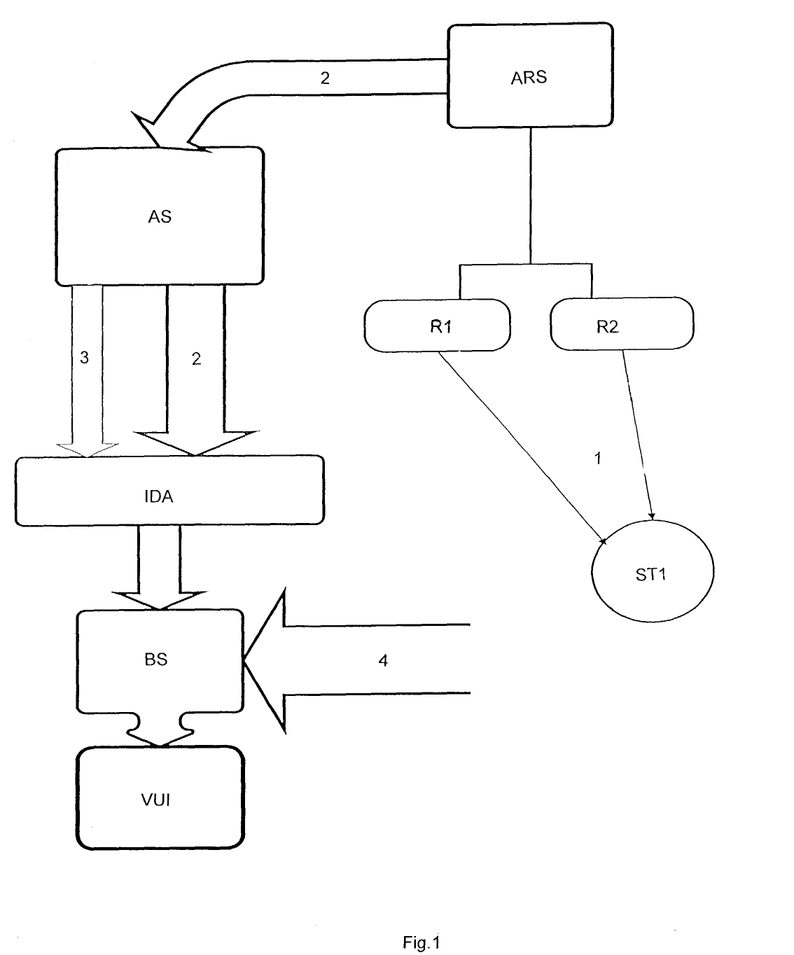

FIG. 1 shows the route taken by video data and positional data associated with a live broadcast to a viewer.

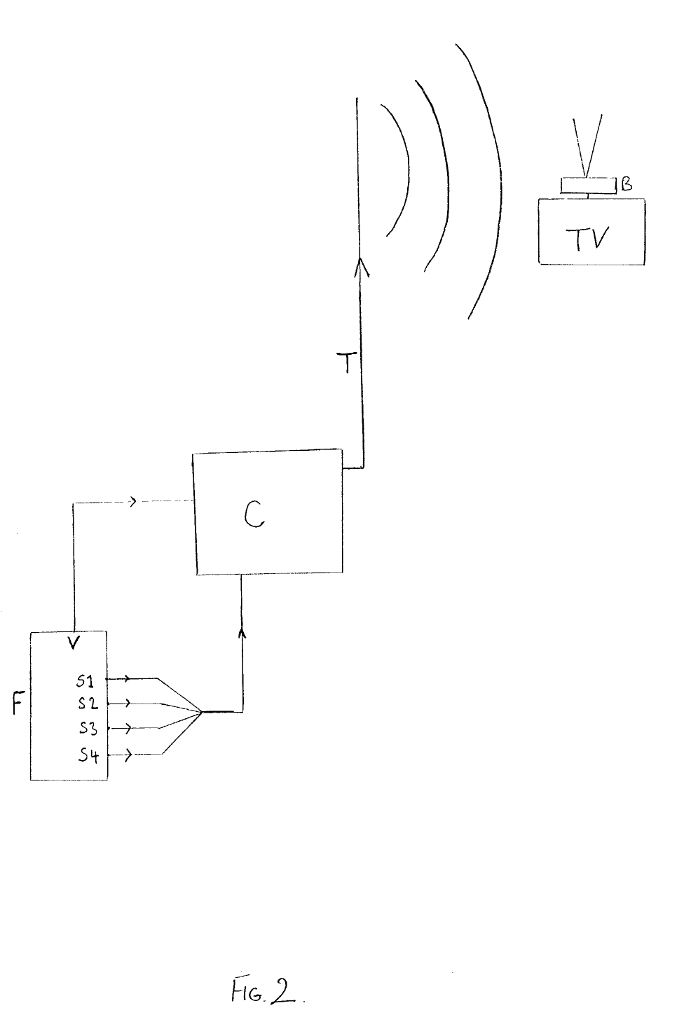

FIG. 2 shows a broadcasting system suitable for use in accordance with the invention.

As can be seen from FIG. 1, a subject of a live event is marked with a signal transmitter ST1. A pair of receivers R1, R2 receive direction data 1 relating to the position of the transmitter ST1. Triangulation is performed on the direction data 1 received by the pair of receivers R1, R2 at an automatic relay station ARS to provide real time positional data 2. An authoring system AS is provided, prior to and/or during the course of the real time event, with pre-authored information 3 concerning the subject. This is carried with the real time information 2 and in association with an interactive data application IDA to a broadcasting system BS receivable by a viewers user interface VUI. Simultaneously, the live broadcast video data 4 is transmitted by the broadcaster, through the broadcasting system, BS and is again received by the VUI. The VUI will typically comprise a TV video broadcast receiver a digital data receiver, and a display for displaying images received by the receivers.

As can be seen from FIG. 2, a broadcasting system has a control centre C which receives video data V of a live action event broadcast from venue F. Position data about a number of subjects of the live action event S1, S2, S3, S4 is also received by the control centre. The control centre C processes the information and may optionally add some pre-authored information. A single transmission T consisting of the video data stream, the position data stream and any optionally added, pre-authored data is subsequently received by a viewer apparatus comprising a black box B, having means for receiving the video and position data streams and a display apparatus such as a television screen TV. The black box B may also include a processor for enabling the operation of an interactive application associated with the event which may, optionally, be downloaded from the control centre C.

It is to be understood that whilst the Figure shows a single transmission from the control centre, the position data may be transmitted to the viewer apparatus in a separate transmission, for example, from a server local to the event venue F which itself receives the position data on subjects S1, S2, S3, S4.

1. A method for providing interactive media coverage for a real time video broadcast of a live action event comprising;
i) in a first data stream, broadcasting video of the live action event for receipt by one or more viewer apparatus;
ii) locating the position of the subjects of the live action event in real time, and
iii) in a second data stream, transmitting position data acquired in step ii) to the one or more viewer apparatus substantially simultaneously with the first data stream.

2. A method as claimed in claim 1, wherein the first and second data streams are transmitted to the viewer apparatus in tandem.

3. A method as claimed in claim 2, wherein said second data stream is multiplexed with said first data stream.

4. A method as claimed in claim 1, wherein further data streams are transmitted to the viewer apparatus.

5. A method as claimed in claim 1, and further comprising providing pre-authored data relevant to the subjects or other aspects of the live action event and transmitting this to the viewer apparatus.

6. A method as claimed in claim 1, and further comprising providing an interactive application program and transmitting this to the viewer apparatus.

7. A method as claimed in claim 1, wherein step ii) involves the use of GPS telemetry.

8. A method as claimed in claim 1, wherein step ii) involves the use of low power, low bandwidth radio telemetry.

9. A broadcasting system for performing the method of claim 1, the broadcasting system comprising; means for receiving video data from the live action event; means for receiving position data of subjects of the live action event; means for processing the data, and means for transmitting the first and second data streams for receipt by a viewer apparatus.

10. A viewer apparatus comprising means for receiving, processing and displaying images associated with the first and second data streams provided by the method and broadcasting system as claimed in claim 1 and 9.

11. A viewer apparatus as claimed in claim 10, and further comprising means for receiving an interactive application program associated with one or both of the data streams.

12. A viewer apparatus as claimed in claim 10, and further comprising a hand-held controller which is configured to enable the viewer to manipulate the interactive data of the second data stream via an interactive application.
